(19) United States
(12) Patent Application Publication
(10) Pub. No.: US 2014/0111502 A1
(43) Pub. Date: Apr. 24, 2014

(54) SCAN DRIVING CIRCUIT OF LCD PANEL, LCD DEVICE, AND DRIVING METHOD

(71) Applicant: Shenzhen China Star Optoelectronics Technology Co., Ltd., Shenzhen (CN)

(72) Inventor: Dongsheng Guo, Shenzhen (CN)

(21) Appl. No.: 13/703,347

(22) PCT Filed: Oct. 26, 2012
(86) PCT No.: PCT/CN2012/083537

§ 371 Date: Dec. 10, 2012

(30) Foreign Application Priority Data
Oct. 23, 2012 (CN) 201210405942.9

(51) Int. Cl. G09G 3/36

(52) U.S. Cl. CPC G09G 3/3674
USPC 345/213

(57) ABSTRACT

The present disclosure discloses a scan driving circuit of a liquid crystal display (LCD) panel, an LCD device and a driving method. The scan driving circuit of the LCD panel includes a time delay component. An input end of the time delay component is coupled to an output enable. An output end of the time delay component is coupled to a dock voltage pulse. A delay time of the time delay component is less than an action time of a single output enable cycle.

### TECHNICAL FIELD

The present disclosure relates to the field of liquid crystal displays (LCDs), and more particularly to a scan driving circuit of an LCD panel, an LCD device, and a driving method.

### BACKGROUND

A liquid crystal display (LCD) panel includes scan lines and data lines which cross the scan lines. The scan lines are controlled by scan driving chips arranged on both sides of the LCD panel. Currently, three control signals are used to control the scan driving chips controlling opening and closing of each of the scan lines of the LCD: a start voltage pulse (STV) controlling a start of a first scan line, a clock voltage pulse (CKV) supplied to a shift register of the scan driving chips to control switching frequency of each line of the scan lines, which starts to act when the STV is detected to be at high level at a rising edge, and an output enable (OE). Because a parasitic capacitor is generated at an inner part of the LCD panel, there is a time delay when a scan output voltage is delivered to the LCD panel. An overlapping problem exists in closing and opening between the scan lines, which leads to an erroneous position of the display data of the LCD panel relative to the data lines of the LCD panel, as shown in FIG. 1. After the OE is inputted, as the GE is at a high level, the output voltage is forced to be reduced. The OE is arranged between opening and closing of lines of the scan lines, which solves the overlapping problem of opening of the two lines of the scan lines, avoiding an improper charging problem of the data, as shown in FIG. 2.

The control signals of the scan driving chips are transmitted to a display of the LCD panel by a printed circuit board assembly (PCBA) via a flexible circuit board of data chips, and then transmitted to the scan driving chips by cables arranged on the display, as shown in FIG. 3.

Currently, a main design of the LCD panel is to have a narrow edge frame. The glass edge is reduced as much as possible using various ways. Thus, saving every tiny space is important. Thus, too much cabling may occupy the space of the glass edge, and the reduction of the number of cabling is necessary.

### SUMMARY

In view of the above-described problems, the aim of the present disclosure is to provide a scan driving circuit of a liquid crystal display (LCD) panel, an LCD device, and a driving method which reduce a cabling of the LCD panel.

The aim of the present disclosure is achieved by the following technical scheme.

A scan driving circuit of an LCD panel. The scan driving circuit of the LCD panel comprises a time delay component. An input end of the time delay component is coupled to an output enable (OE). An output end of the time delay component is coupled to a clock voltage pulse (CKV). A delay time of the time delay component is less than an action time of a single OE cycle.

Furthermore, the time delay component comprises one inverter or more than two inverters that are connected in series. This is a specified circuit structure of the time delay component.

Furthermore, a delay time of the inverter is changeable. The delay time of a single inverter is changeable, which can regulate the delay time within a certain limit. Additionally, a plurality of inverters can be adopted. Thus, a setting of any delay time of the inverter the can be realized by adopting a same kind of inverters, expanding application range of the inverter.

Furthermore, the scan driving circuit of the LCD panel comprises a scan driving chip. The time delay component is integrated, into the scan driving chip. The scan driving chip can generated the OE and the CKV by accepting a control information of a same signal line. Thus, the integration level of the scan driving circuit of the LCD panel can be improved, the reduction of a development cycle is facilitated, and the production is convenient.

An LCD device comprises a scan driving circuit of an LCD panel. The scan driving circuit of the LCD panel comprises a time delay component. An input end of the time delay component is coupled to an OE. An output end of the time delay component is coupled to a CKV. A delay time of the time delay component is less than an action time of a single OE cycle.

Furthermore, the time delay component comprises one inverter or more than two inverters that are connected in series. A delay time of the inverter is changeable. This is a specified circuit structure of the time delay component. The delay time of a single inverter is changeable, which can regulate the delay within a certain limit. Additionally, a plurality of inverters can be adopted. Thus, a setting of any delay time can be realized by adopting a same kind of inverters, expanding application range of the inverters.

Furthermore, the LCD device comprises the LCD panel and a driving circuit board. The LCD panel comprises scan lines and data lines which are crossed. A scan driving chip to drive the scan lines is arranged at a side part of the LCD panel. The time delay component is integrated into the scan driving chip. A data driving chip to drive the data lines is arranged at one side adjacent to the scan driving chip. The driving circuit board is coupled with the data driving chip. The LCD panel is configured with a start voltage pulse (STV) line and an OE line controlling the scan driving chip. The scan driving chip generates the OE and the CKV through the OE line. The OE line is coupled to the input end of the time delay component. The STV line and the OE line are coupled with the driving circuit board through the data driving chip. This is a specified circuit structure of the LCD device.

A method of driving a scan line of an LCD panel comprises the following steps:

A: generating an OE after a scan driving circuit of the LCD panel which sends out a STV, coupling the OE to a time delay component within a conduction cycle of the OE, outputting, a CKV through the time delay component; and

B: driving the scan line by a scan driving chip according to the OE and the CKV generated by a same signal line.

Furthermore, in the step A, the time delay component comprises one inverter or more than two inverters that are connected in series. This is a specified circuit structure of the time delay component.

Furthermore, in the step A, the time delay component is integrated into the scan driving chip of the LCD panel.

In the present disclosure, as the time delay component is adopted, the time delay component can delay a time of a same input signal and then output the input signal. A pulse width driven by each scan line is related to a signal width in one cycle of the CKV and is not directly related to a pulse width of a high-level signal in one cycle of the CKV. Thus, a pulse width of the CKV is consistent with a pulse width of the OE, which can realize the signal multiplexing via the time delay component. The OE is set on the input end of the time delay component, after extended by the time delay component, the OE acts as the CKV, thus reducing the number of control signal lines of a scan driving chip and saving a space for the design of a narrow frame. In addition, reducing the number the control signal lines of the scan driving chip which can increase the space between two control signal lines of the scan driving chip when the control signal lines pass through a chip on flexible printed circuit (COF) which reduces binding difficulty of the COF, the number of pins of a corresponding chip, and packaging cost of the chip.

### BRIEF DESCRIPTION OF THE FIGURES

FIG. 1 is a schematic diagram of a driving waveform of a scan line without a output enable;

FIG. 2 is a schematic diagram of a driving waveform of a scan line with a output enable;

FIG. 3 is a schematic diagram of a scan driving circuit of a typical liquid crystal display (LCD) panel;

FIG. 4 is a principle diagram of realizing signal delay by adopting, a plurality of inverters connected in series in an example of the present disclosure;

FIG. 5 is a schematic diagram of a time difference limit between a output enable and a clock voltage pulse in an example of the present disclosure; and

FIG. 6 is a schematic diagram of a driving waveform in an example of the present disclosure.

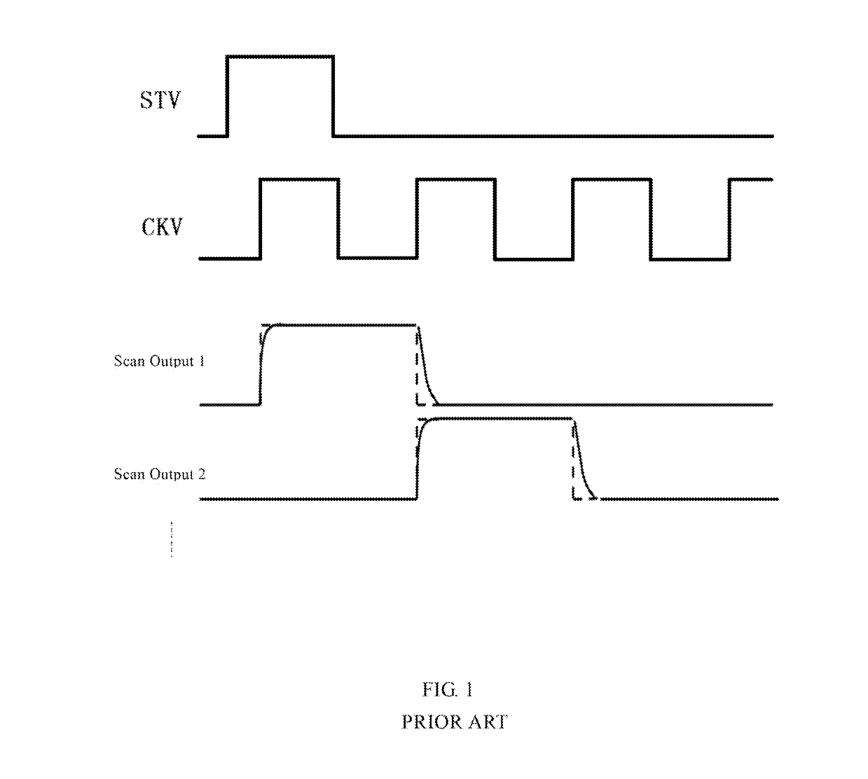

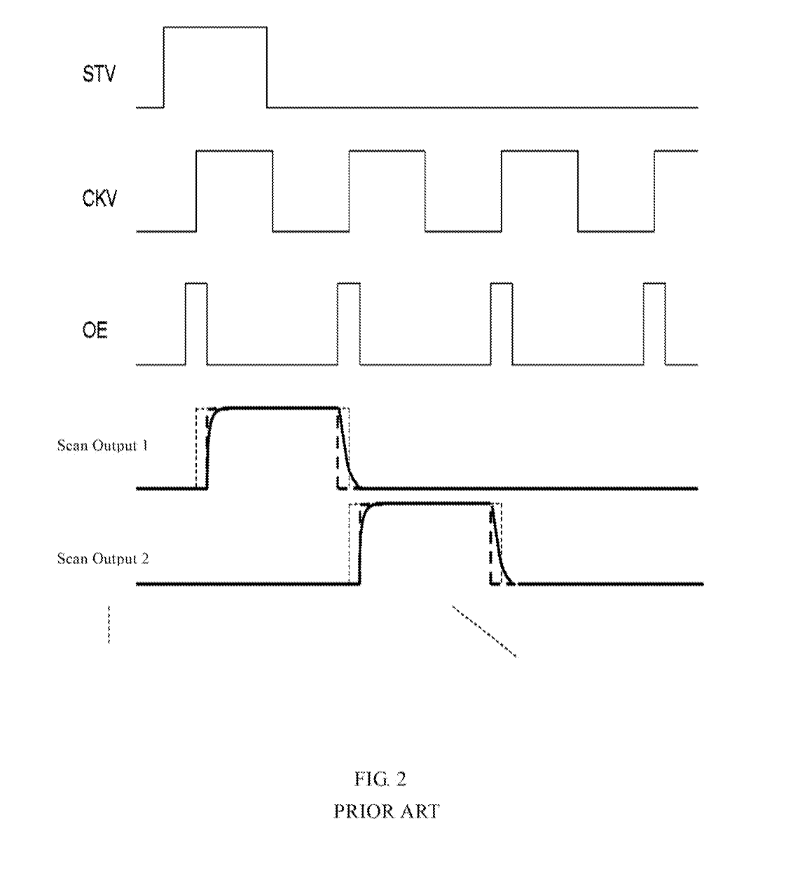

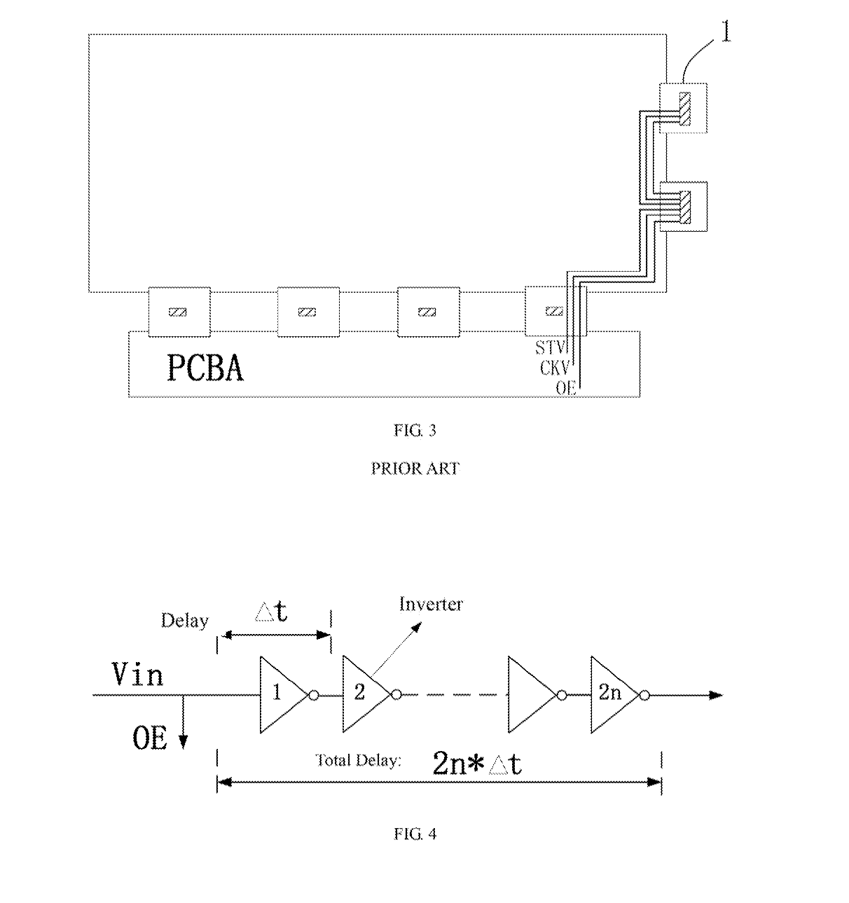

### DETAILED DESCRIPTION

A scan driving circuit of a liquid crystal display (LCD) panel. The scan driving circuit of the LCD panel comprises a time delay component. An input end of the time delay component is coupled to an output enable (OE). An output end of the time delay component is coupled to a dock voltage pulse (CKV). A delay time of the time delay component is less than an action time of a single OE cycle.

In the present disclosure, as the time delay component is used, the time delay component can delay time of an input signal and then output the input signal. A pulse width driven by each scan line is related to a signal width in one cycle of the CKV, and is not directly related to a pulse width of a high-level signal in one cycle of the CKV. Thus, a pulse width of the CKV is consistent with a pulse width of the OE, which can realize signal multiplexing via the time delay component. The OE is set on the input end of the time delay component, after being delayed by the time delay component, the OE acts as the CKV, thus reducing the number of control signal lines of a scan driving chip and saving space for the design of a narrow frame. In addition, reducing the number the control signal lines of the scan driving chip which can increase the space between two control signal lines of the scan driving chip when the control signal lines pass through a chip on flexible printed, circuit (COF), which reduces binding difficulty of the COF, the number of pins of a corresponding chip, and packaging cost of the chip.

The present disclosure is further described in detail in accordance with figures and exemplary example.

An LCD device of the example comprises an LCD panel and a driving circuit board. The LCD panel comprises scan lines and data lines which cross the scan lines. A scan driving chip to drive the scan lines is arranged on a side part of the LCD panel. A data driving chip to drive the data lines is arranged on one side adjacent to the scan driving chip. The driving circuit board is coupled with the data driving chip. The LCD panel is configured with a start voltage pulse (STV) line and an OE line controlling the scan driving chip. A time delay component is integrated into the scan driving chip. The scan driving chip generates an OE and a CKV through the OE line. An input end of the time delay component is coupled to the OE line, and an output end of the time delay component generates the CKV. A delay time of the time delay component is less than an action time of a single OE cycle. The STV line and the OE line are coupled with the driving circuit board through the data driving chip. Certainly, the time delay component of the present disclosure can also be arranged outside the scan driving chip, and then coupled with the scan driving chip through other signal lines.

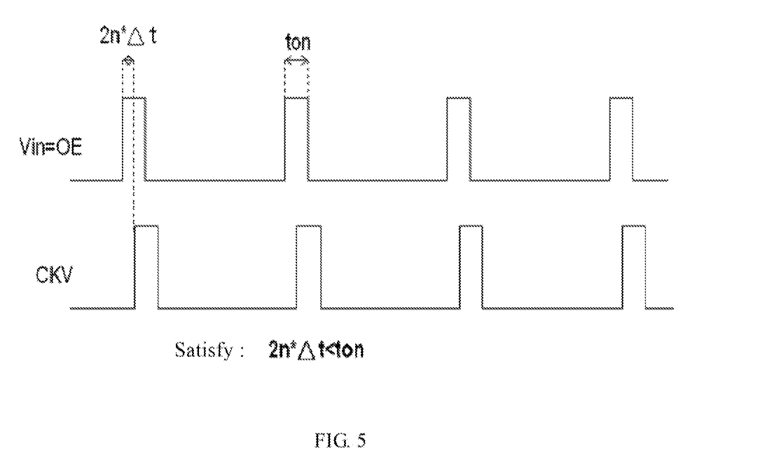

An inverter is adopted by the time delay component in the example. As shown in FIG. 4, a delay time of the inverter is changeable. A plurality of inverters can be connected in series. However, a total extension time 2n*Δt is not allowed to exceed the action time of the single OE cycle (ton) (refer to FIG. 5). The delay time of a single inverter is changeable within a certain limit. Additionally, a plurality of inverters connected in series can be adopted. Thus, a setting of any delay time of inverter can be realized by adopting the same kind of inverter, expanding application range of the inverter.

The example also discloses a method of driving a scan line of an LCD panel, comprising following steps:

A: generating an OE after a scan driving circuit of the LCD panel sends out a STV, coupling the OE to a time delay component within a conduction cycle of the OE, outputting a CKV through the time delay component. The time delay component can be integrated into a scan driving chip of the LCD panel, where the time delay component comprises a plurality of inverters connected in series; and

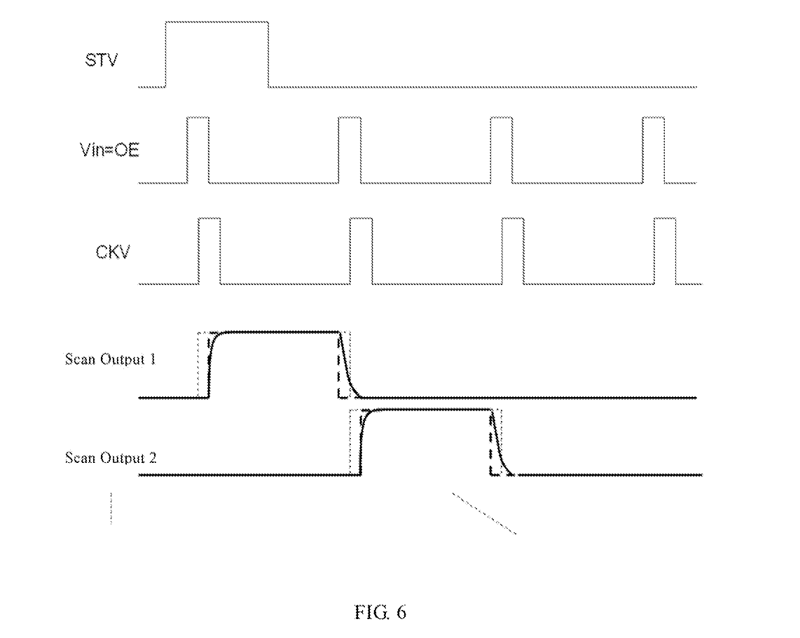

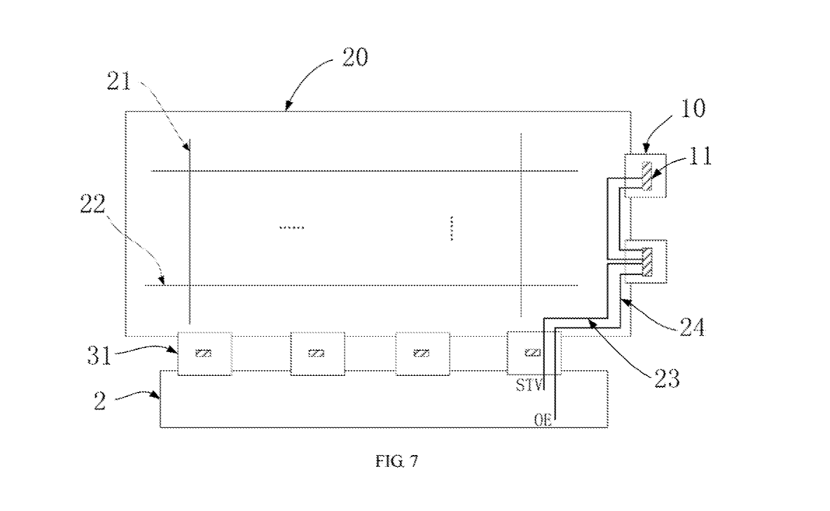

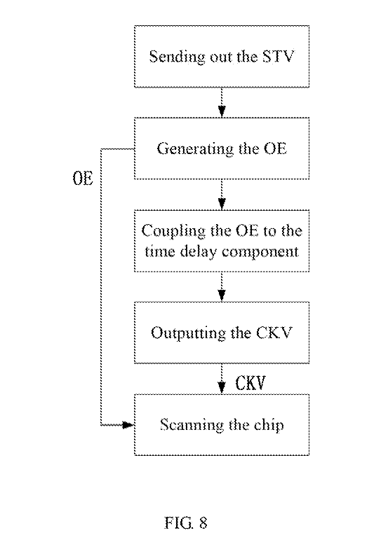

B: driving the scan line by the scan driving chip according to the OE and the CKV generated by a same signal line (refer to FIG. 6 for a driving waveform).

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A scan driving circuit of a liquid crystal display (LCD) panel, comprising:
a time delay component, wherein an input end of the time delay component is coupled to an output enable (OE), an output end of the time delay component is coupled to a dock voltage pulse (CKV), a delay time of the time delay component is less than an action time of a single OE cycle.

2. The scan driving circuit of the liquid crystal display (LCD) panel of claim 1, wherein the time delay component comprises one inverter or more than two inverters that are connected in series.

3. The scan driving circuit of the liquid crystal display (LCD) panel of claim 2, wherein a delay time of the inverter is changeable.

4. The scan driving circuit of the liquid crystal display (LCD) panel of claim 1, wherein the scan driving circuit of the LCD panel comprises a scan driving chip, the time delay component is integrated into the scan driving chip, the scan driving chip generates the OE and the CKV by accepting a control information of a same signal line of the LCD panel.

5. A liquid crystal display (LCD) device, comprising:
a scan driving circuit of an LCD panel, wherein the scan driving circuit of the LCD panel comprises a time delay component, an input end of the time delay component is coupled to a output enable (OE), a output end of the time delay component is coupled to a clock voltage pulse (CKV), a delay time of the time delay component is less than an action time of a single OE cycle.

6. The liquid crystal display (LCD) device of claim 5, wherein the time delay component comprises at least one inverter connected in series, a delay time of the inverter is changeable.

7. The liquid crystal display (LCD) device of claim 6, wherein the LCD device comprises the LCD panel and a driving circuit board; the LCD panel comprises scan lines and data lines which are crossed, a scan driving chip to drive the scan lines is arranged at a side part of the LCD panel, the time delay component is integrated into the scan driving chip; a data driving chip to drive the data lines is arranged at one side adjacent to the scan driving chip, the driving circuit board is coupled with the data driving chip; the LCD panel is configured with a start voltage pulse (STV) line and a OE line controlling the scan driving chip, the scan driving chip generates the OE and the CKV through the OE line; the OE line is coupled to the input end of the time delay component, the STV line and the OE line are coupled with the driving circuit board through the data driving chip.

8. A method of driving a scan line of a liquid crystal display (LCD) panel, comprising:
A: generating a output enable (OE) after a scan driving circuit of the LCD panel which sends out a start voltage pulse (STV), coupling the OE to a time delay component within a conduction cycle of the OE, outputting a clock voltage pulse (CKV) through the time delay component; and
B: driving the scan line by a scan driving chip according to the OE and the CKV generated by a same signal line.

9. The method of driving the scan line of the liquid crystal display (LCD) panel of claim 8, wherein in the step A, the time delay component comprises at least One inverter connected in series.

10. The method of driving the scan line of the liquid crystal display (LCD) panel of claim 8, wherein in the step A, the time delay component is integrated into the scan driving chip of the LCD panel.
